(19) United States
(12) Patent Application Publication
(10) Pub. No.: US 2024/0160006 A1
(43) Pub. Date: May 16, 2024

(54) IONIC LIQUID MIRROR

(71) Applicant: Honeywell International Inc., Charlotte, NC (US)

(72) Inventors: Rebecca Kamire, Buffalo Grove, IL (US); Stephen Yates, South Barrington, IL (US); Neil Rowlands, Nepean (CA); Amanda Childers, Arlington Heights, IL (US)

(21) Appl. No.: 18/474,542

(22) Filed: Sep. 26, 2023

Related U.S. Application Data
(60) Provisional application No. 63/383,670, filed on Nov. 14, 2022.
(60) Provisional application No. 63/483,846, filed on Feb. 8, 2023.

(51) Int. Cl. G02B 26/00; B64G 1/22; B64G 1/66; G02B 5/08; G02B 23/06

(52) U.S. Cl. CPC G02B 26/004; B64G 1/2221; B64G 1/66; G02B 5/08; G02B 23/06

(57) ABSTRACT

An example liquid mirror includes a first ionic liquid and a second ionic liquid. The first and second ionic liquids are immiscible with each other. The liquid mirror also includes a plurality of reflective particles configured to self-assemble at an interface between the first and second ionic liquids.

This application claims the benefit of U.S. Provisional Patent Application 63/383,670, filed 14 Nov. 2022, and U.S. Provisional Patent Application 63/483,846, filed 8 Feb. 2023, the entire contents of both of which are incorporated herein by reference.

### TECHNICAL FIELD

The present disclosure relates to mirrors and techniques for making and using mirrors.

### BACKGROUND

Mirrors for telescopes in space are typically made using solid materials which can be polished such as glass, metal or ceramic and coated with reflective thin films. This approach becomes increasingly expensive with increasing mirror diameter, and increasingly susceptible to damage (e.g., by contact with debris) with increasing mirror diameter.

### SUMMARY

In general, the disclosure describes an ionic liquid mirror and methods of making and/or using ionic liquid mirrors. In some examples, an ionic liquid mirror comprises a first ionic liquid configured to be immiscible with a second ionic liquid and a plurality of reflective particles (e.g., nanoparticles configured to reflect electromagnetic radiation such as ultraviolet, visible, or infrared light, or any suitable wavelength electromagnetic radiation) disposed between the first and second ionic liquids, e.g., at an interface between the first and second liquids. In some examples, the ionic liquid mirror includes a support structure configured to house and/or retain the first and second ionic liquids and particles, and the support structure may be configured to spin, e.g., while experiencing acceleration or the force of gravity, such that at least the interface between the first and second ionic liquids forms a focusing shape, e.g., a parabolic shape. In some examples, the second ionic liquid may also be a ferrofluid and the support structure may be configured to apply a magnetic field to the second liquid such that the first and second ionic liquids forms a focusing shape, e.g., a parabolic shape. For example, the support structure may include one or more magnets configured to apply a magnetic field to at least the first liquid.

In one example, this disclosure describes a liquid mirror including: a first ionic liquid and a second ionic liquid, wherein the first and second ionic liquids are immiscible with each other; and a plurality of reflective particles configured to self-assemble at an interface between the first and second ionic liquids.

In another example, this disclosure describes a vehicle including: a housing configured to couple an engine to a liquid mirror; the engine configured to provide thrust to the housing and liquid mirror in a thrust direction; and the liquid mirror, wherein the liquid mirror comprises: a first ionic liquid and a second ionic liquid, wherein the first and second ionic liquids are immiscible with each other; and a plurality of reflective particles configured to self-assemble at an interface between the first and second ionic liquids.

In another example, this disclosure describes a method of forming liquid mirror, the method including: dispersing a first ionic liquid and a second ionic liquid across a surface of a support structure by applying at least one force to the first ionic liquid or the second ionic liquid, wherein the first and second ionic liquids are immiscible with each other, wherein at least one of the first or second ionic liquids comprises a plurality of reflective particles configured to self-assemble at an interface between the first and second ionic liquids.

The details of one or more examples are set forth in the accompanying drawings and the description below. Other features, objects, and advantages will be apparent from the description and drawings, and from the claims.

### BRIEF DESCRIPTION OF THE FIGURES

FIG. 1 is a schematic cross-sectional view of an example optical system including a liquid mirror.

FIG. 2 is a schematic cross-sectional view of an example a liquid mirror.

FIG. 3A is a structural formula diagram of an example ionic liquid.

FIG. 3B is a structural formula diagram of another example ionic liquid.

FIG. 4 is a schematic illustration of an example orbit of a vehicle including a liquid mirror.

FIG. 5A is a schematic cross-sectional view of a portion of an example liquid mirror without an applied magnetic field.

FIG. 5B is a schematic cross-sectional view of a portion of the example liquid mirror of FIG. 5A in the presence an applied magnetic field.

FIG. 5C is a schematic cross-sectional view of a portion of the example liquid mirror of FIG. 5A in the presence a spatially varying applied magnetic field.

FIG. 5D is a schematic cross-sectional view of a portion of the example liquid mirror of FIG. 5A in the presence an applied magnetic field and tilted relative to a direction of a force.

FIG. 6 is a flow diagram illustrating an example technique of making a liquid mirror.

### DETAILED DESCRIPTION

Use of mirrors for telescopes in space and/or on Earth is well-established, but these solid polished reflectors create a large number of challenges. The cost of making solid reflective mirrors may increase exponentially with increasing mirror diameter, and these mirrors may be relatively easily damaged by contact with debris.

Use of a liquid mirror (LM) for a telescope may be significantly less expensive, more robust, and more rapidly deployed. The cost of making a liquid mirror may increase substantially linearly with increasing mirror diameter. Liquid mirrors may be able to “heal” after contact with debris or after other disturbances of the liquid surface or reflecting surface (e.g., interface) from other forces, e.g., wind, vibration, or the like.

A satellite equipped with a liquid mirror telescope (LMT) comprising an ionic liquid mirror might be employed for orbital debris monitoring, observation of space vehicles, Earth observation, deep-space optical communication, as an astronomical observatory or other applications. A liquid mirror may not need to be robust to the stresses involved in launch, e.g., because a liquid mirror may be deployed post-launch in space and, as also observed on Earth, a liquid surface can be inherently smooth and self-healing.

Earth-based large diameter liquid mirrors may rely on Earth's gravity to help form the liquid into the desired shape (e.g., paraboloid). The surface of a fluid in equilibrium is a constant potential energy surface, which is why most liquids lie flat under the influence of gravity. However, when rotated at a constant angular velocity about a vertical rotation axis, the equipotential surface takes the form of a paraboloid, a shape that focuses light. Light incident upon a reflective liquid surface spinning at a constant angular velocity converges at an effective prime focal point. Earth-based LMTs may only point straight upward and may only be capable of observing objects at the zenith, e.g., are non-tiltable without the introduction of other forces to shape the liquid when pointed off-normal. Space-based LMTs may substitute spacecraft thrust for gravity but are optically limited by containment systems to prevent the liquid component from boiling off in vacuum. For example, Earth-based liquid mirrors may be made using liquid metals, e.g., mercury, which may be too volatile for use in space, e.g., because such liquids may evaporate.

In general, the disclosure describes an ionic liquid mirror and methods of making and/or using ionic liquid mirrors for use as Earth-based mirrors or in space, e.g., in a reduced gravity environment. In accordance with the system, devices, and techniques described herein, a liquid mirror comprises a first ionic liquid immiscible with a second ionic liquid and a plurality of reflective particles configured to self-assemble at an interface between the first and second ionic liquids. In some examples, a liquid mirror comprises two immiscible ionic liquids mixed with reflective nanoparticles to provide a self-assembling stable liquid mirror material comprising a reflective parabolic surface that can be assembled in-situ, e.g., in gravity or microgravity, and healed or replaced when needed. In some examples, self-assembly of reflective particles or nanoparticles may be aided by the force of gravity and/or a magnetic force (e.g., with the application of a magnetic field to the liquid mirror, where the liquid mirror comprises at least one ferrofluid), and by the surface properties of both reflective particles and magnetic particles, the supporting substrate, and properties of the liquid or liquids of the liquid mirror.

Ionic liquids are non-volatile and may not evaporate in space, e.g., substantially outside of the Earth's atmosphere. Ionic liquids are salts, typically organic salts, which have melting points well below room temperature, have essentially zero vapor pressure, and offer the capability of a liquid mirror that can have long term durability in space. In some examples, the liquid or liquids are held in place and shape within the mirror by use of hydrophilic materials, the high surface tension and high viscosity of the liquid, the spin of the parabolic support, and the application of acceleration to the mirror, e.g., via a vehicle, the application of a magnetic field, e.g., a magnetic force, or the like.

Ionic liquids and reflective nanoparticles may be self-assembling, e.g., allowing a focusing and/or mirror shape to form and reform in space under acceleration and with an applied spin. For example, the ionic liquids may be housed with a support structure configured to spin. In some examples, liquid properties such as viscosity may be managed, e.g., via thermal management of the ionic liquids via heating the support structure and/or controlling a temperature of the support structure, to further control self-assembling and/or shape forming properties of the ionic liquids and nanoparticles, and/or enable off-zenith pointing (e.g., on Earth).

Ionic liquids may be much cheaper to make relative to glass mirrors, especially at large diameters. Ionic liquid mirrors can self-heal, which makes them particularly useful for telescopes such as in low Earth orbit, where contact with debris is expected.

In some examples, an ionic liquid mirror housed in a structure mounted to a vehicle may be accelerated and compelled to maintain a light focusing paraboloid shape (e.g., via spinning the structure and liquids) even when tilted out of plane, e.g., tilted by more than 5 degrees, or 10 degrees, or 30 degrees, or 45 degrees, or by any suitable tilt angle. In other examples, an ionic liquid mirror housed in a structure may comprise at least one ferrofluid and the structure may be configured to apply a magnetic field to the ionic liquid mirror such that the ionic liquid mirror is compelled to maintain a light focusing paraboloid shape even when tilted out of plane, e.g., tilted by more than 5 degrees, or 10 degrees, or 30 degrees, or 45 degrees, or by any suitable tilt angle. In some examples, the ionic liquid mirror may be spun (e.g., via the housing structure) in the presence of an acceleration (e.g., gravity, accelerating the ionic liquid mirror mounted to a vehicle, or the like) to form a paraboloidal shape, and in other examples the ionic liquid mirror need not be spun and/or accelerated and the paraboloidal shape of the ionic liquid mirror may be formed and maintained via applying a magnetic field to the ionic liquid mirror comprising a ferrofluid. In some examples, when the magnetic force is applied, the shape can be maintained even against gravity or an acceleration, e.g., if the mirror is tipped off zenith. In some examples, an ionic liquid mirror may have a diameter of less than or equal to 1 meter, or more than 1 meter, or more than 5 meters, or more than 10 meters, or any suitable diameter.

In some examples, a liquid mirror that self-assembles from two immiscible liquids may be Metallic Liquid-like Fluids (MELLFs) using silver or gold nanoparticles in a two liquid phase system. For example, one phase may be an ionic liquid, and the nanoparticles may be generated or suspended in the ionic liquid, and then the nanoparticle surfaces may be modified to make the surfaces non-wetted by the ionic liquid. A second immiscible liquid phase may be present, and the particles may aggregate at the interface between the two phases, self-assembling into a mirror. The surface properties of the particles may be adjusted such that, even after shaking the two-liquid mixture, the liquid mirror may reappear (e.g., re-self-assemble). To create a parabolic mirror, a parabolic support can be spun to spread the liquid while a downward force (gravity or other) holds the liquid against the support surface. In other examples, one phase may be a first ionic liquid and the second phase may be a second ionic liquid immiscible with the first ionic liquid. In some examples, one or both of the first and second ionic liquids may comprise water.

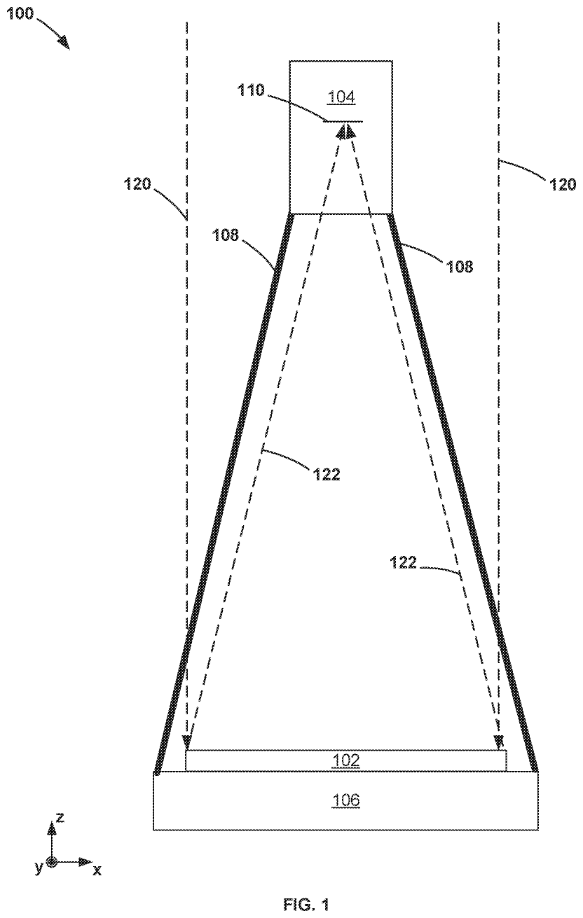

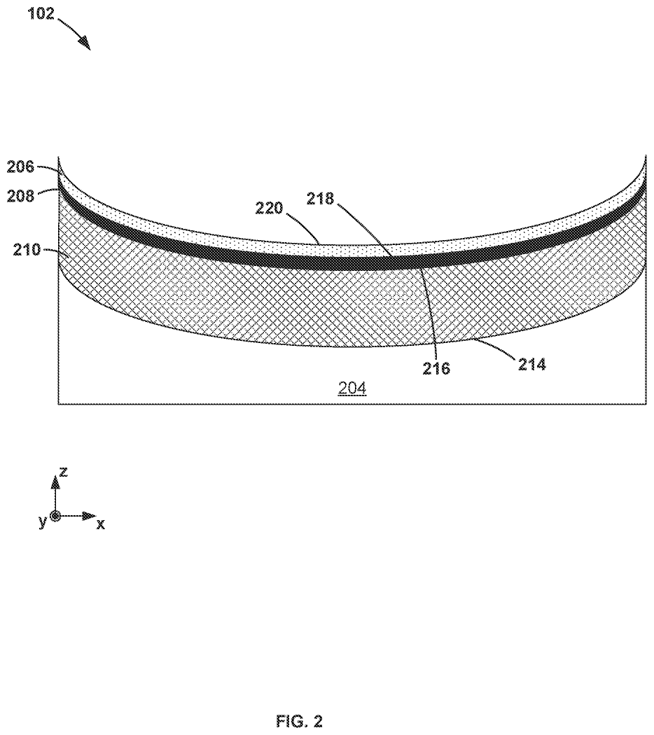

FIG. 1 is a schematic cross-sectional view of an example optical system 100 including a liquid mirror 102. FIG. 2 is a schematic cross-sectional view of example liquid mirror 102. FIGS. 1 and 2 are described together below. In the examples shown, optical system 100 may be at least a portion of a LMT which may be attached to, carried by, or included with a vehicle, e.g., a space or aerial vehicle.

Referring to FIG. 1, optical system 100 includes liquid mirror 102, mirror support structure 106, detection module 104, and struts 108 which may be configured to support, position, and hold detection module 104 relative to support structure 106 and liquid mirror 102.

Detection module 104 may include re-imaging optics, e.g., any suitable optical elements including lenses, flat mirrors and/or focusing or non-focusing curved mirrors, diffractive and/or holographic optical elements, windows, spatial and/or spectral filters, or the like. Detection module 104 may also comprise focal plane 110. For example, liquid mirror 102 may be configured to, in conjunction with detection module 104, focus incident light 120 to focal plane 110. Focal plane 110 may be flat or curved. In some examples, focal plane 110 may comprise a focal plane array configured to capture an image of a scene via incident light 120, e.g., a focal plane array of a camera.

Mirror support structure 106 and struts 108 may be configured to provide mechanical support and positioning of liquid mirror 102 and detection module 104, e.g., to maintain the positions and optical axes of liquid mirror 102 and detection module 104 relative to each other.

Liquid mirror 102 is configured to reflect incident light 120 to optical detection module 104, e.g., as reflected light 122. In some examples, liquid mirror 102 may have optical power to converge or diverge incident light 120. For example, liquid mirror 102 may have a reflecting surface having a curved shape, such as a spherical or parabolic two-dimensional shape or one-dimensional (e.g., cylindrical) shape. In some example, liquid mirror 102 may be a primary mirror of an LMT, and detection module 104 may comprise a secondary mirror or lens of the LMT.

Referring to FIG. 2, liquid mirror 102 may comprise mirror base 204, a first ionic liquid 206, reflective layer 208, and second ionic liquid 210. Mirror base 204 may comprise a front surface (e.g., a forward-facing surface facing incident light 120) that may have a shape, e.g., flat, curved, spherical, parabolic, or the like. The front surface of mirror base 204 may be at a mirror base interface 214 with second ionic liquid 210. Reflective layer 208 may comprise a plurality of reflective particles that are configured to self-assemble at an interface between first ionic liquid 206 and second ionic liquid 210, e.g., forming interface 216 between reflective layer 208 and second ionic liquid 210 and interface 218 between reflective layer 208 and first ionic liquid 206.

In some examples, reflective layer 208 may have a thickness (e.g., nominally in a direction towards mirror base 204 or the z-direction substantially in the middle of liquid mirror 102) that is less than about 10 micrometers, or less than about 1 micrometer, or less than about 500 nanometers, or less than about 100 nanometers, or less than about 50 nm, or a thickness that is about the nominal size of the thickness of the reflective particles (e.g., a “single layer” of reflective particles). In some examples, interfaces 216 and 218 may be considered to be a single interface (referred to herein as interface 216) between ionic liquids 206, 210, e.g., reflective layer 208 may be considered to be a collection of particles or nanoparticles with sufficient surface density at interface 216 to have sufficient reflectivity (e.g., as opposed to a “layer”). In the example shown, first ionic liquid 206 may have a top surface 220 which may be flat, curved (as shown), or have any surface profile, e.g., top surface 220 may not appreciably contribute to reflecting incident light 120 and/or image formation using liquid mirror 102. In some examples, first ionic liquid 206 may have a thickness that is less than about 100 micrometers, or less than about 10 micrometers, or less than about 1 micrometer, or less than about 100 nanometers. In some examples, second ionic liquid 210 may have a thickness that is less than about 10 millimeters, or less than about 5 millimeters, or less than about 1 millimeter, or less than about 500 micrometers.

In some examples, to allow the liquid mirror 102 to be operable under the vacuum and temperatures of space, ionic liquids for both liquids in the MELLF process may be used. Reflective particles or nanoparticles may self-assemble at the interface between the two ionic liquids, forming the reflective layer 208. The top ionic liquid layer (e.g., relative to incident light 120 and shown as second ionic liquid 210) may be relatively thin, e.g., having a minimized thickness, to avoid attenuating the incident light 120 reaching the mirror, while the base ionic liquid layer (e.g., shown as second ionic liquid 210) may be configured to provide the optical-quality surface, e.g., which may be at interface 216. The mirror base 204 need not have wavefront accuracy, e.g., it may only be accurate to 100's of microns, while the liquid interface 216 follows the shape dictated by the acceleration (e.g., which may be in the zenith or z-direction as shown) and spin (which may be clockwise or counter-clockwise about the zenith or z-direction, e.g., substantially in the x-y plane as shown) and may have a paraboloid shape having a suitable wavefront accuracy, e.g., to an accuracy much less than 1 micron, over the area of the mirror. In some examples, mirror base 204 may include permanent and/or tunable magnets.

In some examples, the ionic liquids 206, 210 may be configured to allow control of density, viscosity, surface tension, vapor pressure, thermal conductivity, melting point, surface contact angle (e.g., with a surface of a housing and/or the support structure), interfacial contact angle (e.g., between the ionic liquids at interface 216), and any other suitable property. For example, first ionic liquid 206 may be 1-butyl-3-methylimidazolium acetate (BMIM Ac), which may be transparent (e.g., for light having at least visible wavelengths), may have a melting point of about −77° C. (e.g., about 196 Kelvin), a viscosity of about 297 millipascal-seconds (mPa-s) at room temperature, and a surface tension of about 36 milli-Newtons per meter (mN/m). In some examples, the liquid properties allow the ionic liquids (e.g., ionic liquids 206 and/or 210) to flow during creation and/or formation of the liquid mirror, to avoid freezing during subsequent use, and/or to require low power input for maintenance of the paraboloid once formed. In some examples, BMIM Ac (and other ionic liquids) may have negligible volatility and may be exposed to the vacuum of space substantially without evaporation from the surface. In some examples, BMIM Ac (and other ionic liquids) may be sensitive to temperature, such that upon cooling, a glass-like material may be generated and/or formed on the surface of ionic liquid 206 and/or 210, and/or the entire volume of the ionic liquids 206 and/or 210 may form a glass-like material. For example, a transparent and substantially defect-free glass-like material may be formed on the surface to further simplify LMT operations.

In some examples, liquid mirror 102 may use an atomic deposition technique to create the reflective surface, or may use the MELLF technique/process, or may use a different technique/process. For example, BMIM Ac is soluble in water, and the processes necessary to make or suspend metallic nanoparticles may be completed in a neat ionic liquid (e.g., in neat BMIM Ac), in an ionic liquid-water solution from which the water may be subsequently evaporated, or via any suitable method of suspending and distributing the nanoparticles.

In some examples, a second immiscible ionic liquid 210 may be a second phase. For example, a hydrophobic phosphonium ionic liquid is immiscible with hydrophilic imidazolium ionic liquids like BMIM Ac, and mixing the two may generate two liquid phases separated by an interface 216, e.g., via a mixing device that may apply a shear to make sure that the surfaces of the particles of reflective layer 208 are fully exposed to the two liquids (or in some examples, shaking a mixture of the two may generate two liquid phases separated by an interface). In some examples, the liquid for second ionic liquid 210 may also be optically transparent, have a lower density than the first ionic liquid 206, have a low melting point, and may have a viscosity configured for forming the mirror, e.g., to flow to a paraboloid shape configured to focus light to a predetermine focal point or range of focal points. In some examples, each of the first and second mutually immiscible liquids 206, 210 may have at least one matched anion. In some examples, first ionic liquid 206 may comprise a hydrophobic cation, or a hydrophobic phosphonium cation, and second ionic liquid 210 may comprise a hydrophilic cation, or a hydrophilic imidazolium cation.

In some examples, the material of mirror base 204 may be selected to aid in liquid self-assembly and liquid mirror chemical and physical stability. For example, mirror base 204 may have a hydrophilic top surface, e.g., at interface 214, which may induce the more hydrophilic ionic liquid (e.g., of the two ionic liquids or phases, which may be second ionic liquid 210) wet the surface and form the “base layer” or second ionic liquid 210. The other ionic liquid and/or phase (e.g., first ionic liquid 206) may be pushed to the top. The attraction between the two hydrophilic materials of first and second ionic liquids 206, 210 may help hold the liquid mirror in place. Chemical stability may also be provided by appropriate material selection. For example, since ionic liquids are conductive, they may tend to corrode metal surfaces if the liquid is in contact with multiple metals. To avoid corrosion of the reflective particles or the parabolic surface of mirror base 204 at interface 214 and/or to improve the hydrophobic or hydrophilic properties of the reflective particles to improve forming the reflective layer 208 (and if the surface is metallic), it may be beneficial to coat the reflective particles and/or the parabolic surface in a hydrophilic (or hydrophobic) organic material. In some examples, in space, the ionic liquids 206, 210 may be exposed to solar radiation or ionizing cosmic radiation, and materials may be selected that are more durable to this exposure. In some examples, the reflective particles of reflective layer 208 may include gold, silver, or other particles or nanoparticles.

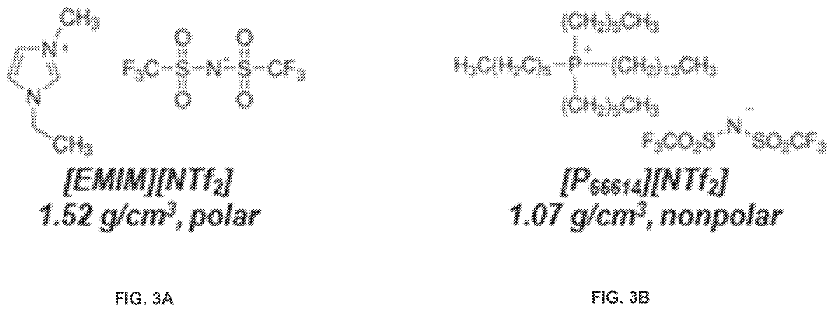

FIG. 3A is a structural formula diagram of an example ionic liquid, and FIG. 3B is a structural formula diagram of another example ionic liquid. FIGS. 3A and 3B are described together below.

In some examples, one or both of the first and second ionic liquids 206, 210 may be polar or nonpolar. For example, as shown in FIGS. 3A and 3B, an ionic liquid may comprise 0.3-0.99 mol fraction of 1-ethyl-3-methylimidazolium bis(trifluoromethylsulfonyl)amide ([EMIM][NTf2]) in trihexyltetradecylphosphonium bis(trifluoromethylsulfonyl)amide ([P66614][NTf2]), which forms two phases at 20-120° C., e.g., a first phase illustrated in FIG. 3A and a second phase illustrated in FIG. 3B.

In some examples, ionic liquid pairs 206, 210 may be selected based on the criteria of mutual insolubility, density difference, polarity difference (frequently assessed as a difference in surface tension) and/or other criteria. In some examples, the anion for each ionic liquid 206, 210 may be the same as that for the other one, to avoid generating mixed pairs. Anions may include bis(trifluoromethylsulfonyl)amide, bismethanysulfonylimide, bis(perfluoroethylsulfonyl)imide, trifluoroethanesulfonate, hexafluorophosphate and tetrafluoroborate. Cations for the nonpolar cation may include tetraalkylphosphonium and tetraalkyl ammonium with the alkyl groups separately containing between 4 and 20 carbons. Cations for the polar cation may be selected from 1,3-dialkylimidazolium, N,N-dialkyl pyrrolidinium and N-alkylpyridinium cations, where “alkyl” refers to alkyl groups with less than 4 carbons and may include hydroxylalkyl groups.

In some examples, [EMIM][NTf2] in [P66614][NTf2] may have a density of about 1.52 g/cc, a viscosity at 20 degrees C. of about 35.5 centipoise (cP) and a surface tension of about 41.6 mN/m.

Referring back to FIG. 2, in some examples, a self-assembled LMT may be deployed and regenerated in space. For example, a LMT may be launched with the liquid(s) in a reservoir or reservoirs (e.g., which may be within support structure 106 of FIG. 1, or another structure not shown), to be flowed into or onto mirror base 204 after the LMT has reached its target orbit. A parabolic surface of mirror base 204 may then be spun at a velocity that spreads the liquid mirror 102 to cover a surface of mirror base 204 (e.g., with a coalescence time of about 0.01 seconds, or about 0.1 seconds, or about 0.37 seconds, or about 0.5 seconds, or about 1 second, or about 10 seconds, or any suitable coalescence time, e.g., depending on a gravity and/or acceleration force, spin velocity, and material properties), and a vehicle may provide an acceleration to the LMT. In some examples, surface tension and interfacial tension may contribute to holding the liquid (e.g., second ionic liquid 210) against the surface (e.g., of the support structure) and holding the interface 216 containing the reflective particles or nanoparticles in place. In some examples, a high surface tension and interfacial tension may contribute to reducing the power required for acceleration to hold the mirror in place, e.g., hold first ionic liquid 206, reflective layer 208, and/or second ionic liquid 210 in place.

In some examples, ionic liquids with appropriate viscosities, thermal conductivities, and glass transition temperatures may aid in maintaining the liquid mirror 102 throughout its life cycle. For example, raising the temperature of the mixture may be used to reduce liquid viscosity to accelerate liquid mirror 102 formation, followed by cooling to preserve the liquid. Once liquid mirror 102 has been formed, lowering the temperature, and hence increasing the viscosity, of liquid mirror 102 may cause liquid mirror 102 to resist flow or even immobilize the interfaces 214, 216, 218, and/or surface 220 of liquid mirror 102. A cooled viscous surface may aid in preserving the surface when, for example, forces needed to steer a satellite or point the LMT are applied. Alternatively, liquid mirror 102 may be discarded, e.g., pumped to a reservoir or reservoirs and optionally filtered to remove any debris, micrometeoroids, or the like, and then restored/reformed later, e.g., to repair liquid mirror 102 following impacts to 214, 216, 218, and/or surface 220 such as from micrometeoroids or small debris strikes, or to repair and/or reform liquid mirror 102 after tilting and/or moving liquid mirror 102, e.g., resulting from a vehicle maneuver.

In some examples, the ionic liquid materials may be configured to have a reduced hygroscopic property. In some examples, the ionic liquid materials may be configured to be protected from moisture until launched into space.

In ground based LMTs a paraboloid surface may be formed by spinning the liquid mirror along an axis parallel to the local force of gravity. In space, in a stable orbit, the gravitational force of the LMT goes into the centripetal acceleration creating the orbital motion so that, to first order, there are no forces acting on the spacecraft/container and liquid against which the liquid can be shaped. In some examples, to create the contact force that allows the spinning platform to shape the mirror, an additional force may be applied, e.g., acceleration from thrusters when an orbit of a satellite is raised. The parabolic surface may be spun around the thrust vector (e.g., thrust-direction axis) to hold the liquid against the parabolic surface while maintaining the liquid (e.g., paraboloid) shape.

In some examples, for continuous LMT observations, a vehicle and/or spacecraft acceleration may be continuous, and may be provided by, for example, ion engines. Ion engines may provide a low continuous thrust driven by solar energy and xenon fuel. A high specific impulse of the xenon fuel may translate to a low delta-V, an indirect metric for propellant mass. The amount of propellant required may be a magnitude less than with conventional chemical thrusters. For example, the NASA-developed NSTAR electrostatic ion thruster may be applied, e.g., to provide 0.092 N of thrust, or any suitable thrust.

For example, a spacecraft may have a mass of about 1,000 kilograms (kg) and an available acceleration of 9.2×10⁻⁵ m/s². A rotation rate of about once per hour may be provided by a support structure to form a 10 meter diameter F/2 primary mirror, e.g., via trim thrusters. Various attitude control and/or sensing technologies may be used for such a spacecraft configuration.

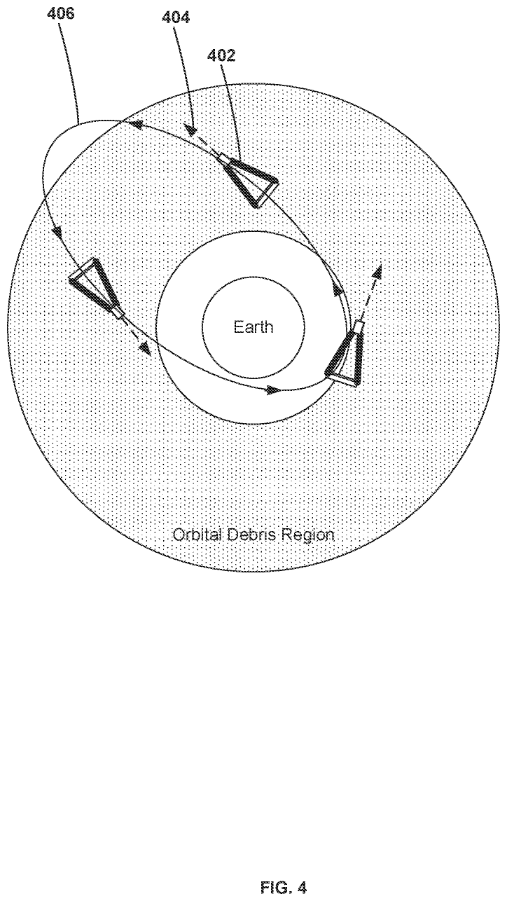

FIG. 4 is a schematic illustration of an example LMT 402 orbit 406 to observe space debris. LMT 402 may comprise liquid mirror 102. An acceleration, e.g., a thrust in a thrust direction 404, for orbit raising may be in the same direction as the orbital motion. If the spacecraft spins around the thrust vector 404 and this thrust is maintained around an entire orbit, then the LMT 402 field of view may scan a large arc across the sky as shown in FIG. 4, or the LMT 402 may periodically point in other directions for short periods of time, e.g., to increase the field of view. Although FIG. 4 illustrates an elliptical orbit 406, other orbits may be used, e.g., a circular and/or continuously expanding orbit. In some examples, once the orbit has been raised sufficiently, the LMT 402 may leave the volume of the debris cloud and may no longer be able to observe it. At this point the process may be reversed by application of the thrust in the opposite direction of orbital motion, lowering the orbit.

In some examples, a LMT 402 may be configured for detailed inspection of specific spacecraft, e.g., when the LMT 402 is in proximity to a target. For example, at a distance of about 200 kilometers (km) distance, details as small as about 1 centimeter (cm) may be resolvable. In some examples, the LMT 402 may be configured to be a 10 meter diameter diffraction limited space LMT 402 with an angular resolution of about 10 milli-arcseconds, which may be sufficient to identify the functionality of a geostationary (GEO) spacecraft from a low-earth orbit (LEO), or to perform detailed inspection from distances of a few hundred kilometers, and/or would be of significant interest for astronomical imaging.

In some examples, the LMT 402 may be configured for targeted observations of the Earth's surfaces. For example, the LMT 402 may have an orbital geometry to maintain a pointing direction towards earth via thruster acceleration, or the liquid mirror 102 liquid(s) may be cooled to increase viscosity such that the LMT 402 may be pointed in a direction different than the thrust acceleration (e.g., towards Earth's surface, or any direction). Thermal management may be employed to maintain the mirror shape of liquid mirror 102, e.g., during debris observation, target observation, Earth observation, outer space observation, or the like.

In some examples, mirror base 204 may have a paraboloid shape (e.g., at a surface of mirror base 204 at interface 214) and/or may provide thermal management of liquid mirror 102 during use and during temperature swings used for maneuvers or mirror regeneration as described above. In some examples, to avoid stray light from the sun or Earth, the LMT 402 orbit may be positioned with liquid mirror 102 primarily facing deep space. The orbit may be arranged to minimize eclipses and thus portions of the spacecraft may always be heated by sunlight to approximately 50-300 K. The spin of the LMT 402 may be configured to distribute heat across liquid mirror 102. In some examples, heat pipes may be used to transfer heat to interface 214 and first and/or second ionic liquids 206, 210. In some examples, power may be applied to heat the surface of mirror base 204 at interface 214. Cooling can be accomplished by turning off heat pipes, and/or the LMT 402 may be cooled actively.

Referring to FIGS. 1-4, optical system 100 may comprise a full-scale liquid mirror 102 and may be spun into place on a parabolic mirror base 204 have a 10 meter diameter with a 0.3 meter depth of curvature in a 1 millimeter to 2 millimeters liquid layer, e.g., all of first ionic liquid 206, reflective layer 208, and second ionic liquid 210 having a combined nominal thickness of between about 1 millimeter to about 10 millimeters. The optical focus (e.g., the effective focal length) may be 20 meters from the primary mirror, e.g., liquid mirror 102. Auxiliary optics may provide image quality across, for example, a moderate field of view. The optics and camera of detection module 104 may be deployed on struts 108 which may be similar to, for example, those used for the James Webb Space Telescope's secondary mirror. Alignment between the optics/camera and the primary mirror may be actively controlled, such as by a laser tracker system, to accommodate for thermal distortions.

In some examples, the rotation rate to maintain the optical surface, e.g., reflective layer 208 and/or interface 216, may be proportional to the square root of the applied acceleration and inversely proportional to the square root of the mirror diameter. For example, a relatively small 1 meter diameter space LMT 402 may be spun 3 times faster or the acceleration of the LMT 402 may be 3 times less, relative to a 10 meter diameter liquid mirror 102.

Scaling a liquid mirror 102 in space may reduce some of the challenges faced on Earth when increasing liquid mirror 102 diameter, such as ripples caused by air flow over the surface or structural resonant vibrations. In space, few forces act on interfaces 214, 216, 218, and/or surface 220. In some examples, at large scale, an LMT 402 may be configured to reduce and/or compensate for time-variable effects and/or precession effects due to the orbital motion and any tilts of the rotation axis. For example, perturbations caused by the precession effects may induce a standing wave on liquid mirror 102 that is stationary in the non-rotating frame, which may have a significant impact on optical image quality unless controlled. In some examples, the amplitude of the surface displacement is greatest at a rim and/or radial edge region of liquid mirror 102 and decreases exponentially with radial distance inward from the rim and/or radial edge, and the LMT 402 may be configured to reduce and/or compensate for such effects.

For example, the materials used in the LMT may be selected to minimize the precession effects, while balancing the impact on power and time required to prepare interfaces 214, 216, 218, and/or surface 220. High surface tension and high viscosity ionic liquids 206, 210 may reduce the amplitude of standing waves. The first (top) and second (base) ionic liquids, and the material of mirror base 204 or the surface of mirror base 204 at interface 214, may be configured for high interfacial tension to mitigate precession effects. In some examples, the surface of mirror base 204 at interface 214 may be shaped and/or configured to provide a thin film of a predetermined static shape (e.g., a paraboloid, a predetermined shape as a function of position, or any suitable shape).

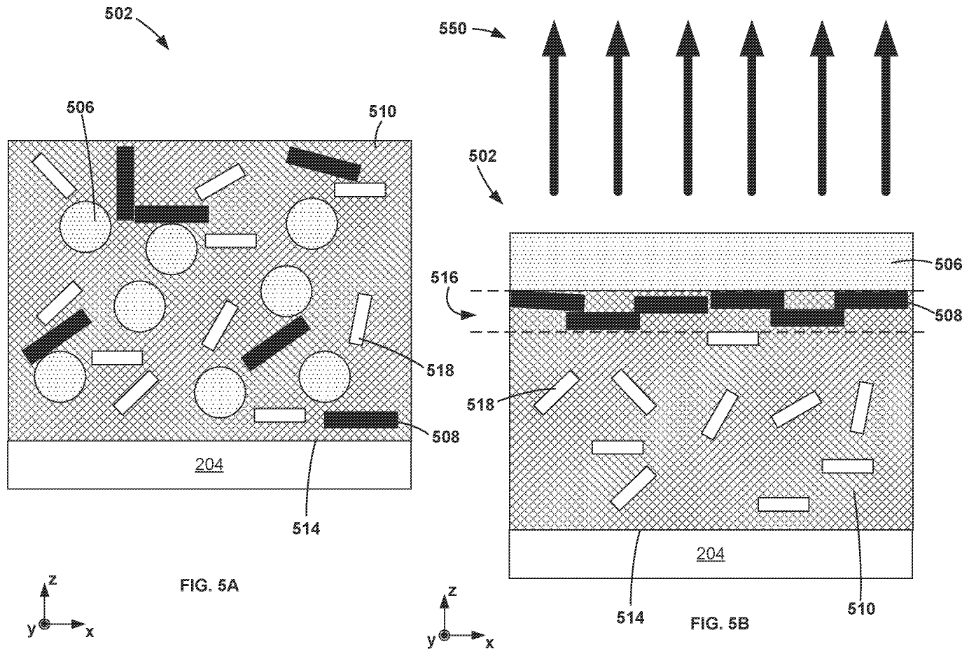

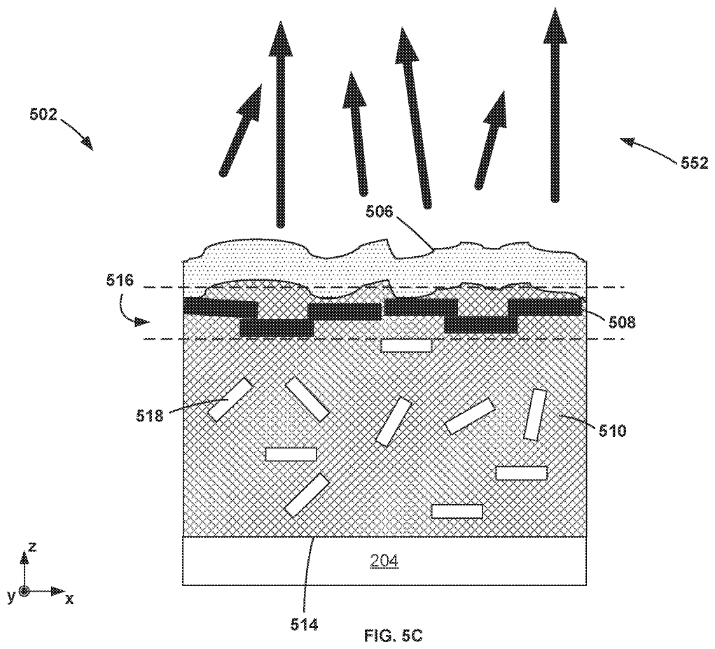

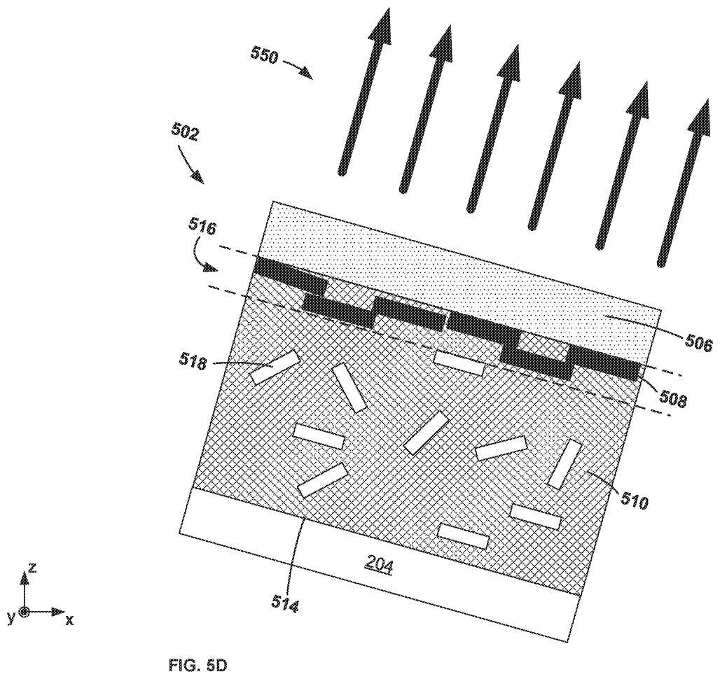

FIG. 5A is a schematic cross-sectional view of a portion of an example liquid mirror 502 without an applied magnetic field, FIG. 5B is a schematic cross-sectional view of a portion of the example liquid mirror 502 of FIG. 5A in the presence an applied magnetic field 550 (illustrated as magnetic vectors which may results from magnetic field 550), FIG. 5C is a schematic cross-sectional view of a portion of the example liquid mirror 502 of FIG. 5A in the presence a spatially varying applied magnetic field 552 (illustrated as magnetic vectors which may result from spatially varying magnetic field 552), and FIG. 5D is a schematic cross-sectional view of a portion of the example liquid mirror of FIG. 5A in the presence an applied magnetic field 550 and tilted relative to a direction of a force. Liquid mirror 502 may be substantially similar to liquid mirror 102 described above, except for the differences described herein.

Liquid mirror 502 includes first ionic liquid 506 and second ionic liquid 510. First ionic liquid 506 may be substantially the same as first ionic liquid 206, except that first ionic liquid 506 may be a non-polar IL (nonpolar IL 506). Second ionic liquid 510 may be substantially the same as second ionic liquid 210, except that second ionic liquid 510 may be a polar ionic liquid (polar IL 510) comprising a ferrofluid. In some examples, the polar IL 510 may comprise a plurality of magnetic particles 518 suspended in the polar IL 510. FIGS. 5A and 5B illustrate the formation and maintenance of a liquid mirror 502 having a focusing shape, such as a parabolic reflecting surface shape, without acceleration and/or spinning the liquid mirror 102 (or without accelerating and/or spinning a structure housing the liquid mirror, e.g., optical system 100 and/or LMT 402). As shown in FIGS. 5A and 5B, a magnetic field 550 may hold the ionic liquids 506, 510 (e.g., the polar IL 510 and non-polar IL 506) against the mirror base 204 (which may be a structure configured to house the liquid mirror 502) and spread the ionic liquids 506, 510 across the dish, e.g., replacing spin and acceleration.

In the examples shown in FIGS. 5A and 5B, the liquid mirror 502 also comprises reflective particles 508 comprising a nonpolar coating and magnetic particles 518 comprising a polar coating. In some examples, the reflective particles 508 may be nanoparticles having a modified surface configured to not wet, or not be well-wetted, by the polar IL 510. For example, the reflective particles 508 may be configured to position and/or self-assemble at an interface 516 between the polar IL 510 and nonpolar IL 506 at thermodynamic equilibrium. In some examples, the magnetic particles 518 may be nanoparticles having a modified surface configured to preferentially be wetted by the polar IL 510.

In some examples, nonpolar IL 506 may have a lower density than polar IL 510 and may “float” on top of polar IL 510, e.g., at a surface away from mirror base 204. Reflective particles 508 may have a relatively higher density such that reflective particles 506 migrate to the interface between nonpolar IL 506 and polar IL 510 rather than dispersing within nonpolar IL 506, and the volume of nonpolar 506 may be substantially small, e.g., such that reflective particles 518 do not disperse within, or are held in suspension, within nonpolar IL 506.

In the example of FIG. 5A, the polar IL 510, nonpolar IL 506, reflective particles 508, and magnetic particles 518 may be homogeneously mixed, e.g., in the absence of a magnetic field 550. In the example of FIG. 5B, with the application of a magnetic field 550, e.g., via one or more magnets such as permanent magnets, electromagnets, or any suitable magnets, the magnetic field 550 may induce magnetism in the magnetic particles 518. For example, each particle of the magnetic particles 518 may be sized such that it comprises one magnetic domain. The induced magnetism may cause the magnetic particles 518 to be mutually attracted to each other, and also to be attracted to the magnets, e.g., which may be underlying and/or within mirror base 204. The polar IL 510 may move along with the magnetic particles 518, e.g., via wetting to the magnetic particles 518, and may also move to the surface of mirror base 204 at interface 514. In some examples, the polar IL 510 may have an affinity for the magnetic particles 518 such that the magnetic particles 518 do not settle out of the polar IL 510 or concentrate at the bottom of the polar IL 510, e.g., near interface 514, or by the mirror surface or interface 516. For example, polar IL 510 may additionally be a ferrofluid comprising magnetic particles 518 configured to be suspended in the ferrofluid. As a result of the movement of polar IL 510 (e.g., with the application of magnetic field 550), nonpolar IL 506 may segregate and/or separate from polar IL 510 and form a layer floating on the polar IL 510, e.g., since nonpolar IL 506 does not wet well to the magnetic particles 518. For example, the nonpolar IL 506 may float to the surface of the polar IL, forming interface 516, and nonpolar IL 506 may be held to the surface of the polar IL by interfacial tension. The reflective particles 508 may be driven to the interface 516, forming a reflective surface and/or interface 516, e.g., the mirror surface. For example, the reflective particles 508 may comprise a nonpolar surface such that the reflective particles 508 minimize their contact with the polar IL 510, but the nonpolar surface of the reflective particles 508 may not be nonpolar enough to disperse in the nonpolar IL 506. The reflective particles 508 may then migrate, move, and/or self-assemble at the interface 516 between the polar IL 510 and nonpolar IL 506.

In some examples, the magnetic field 550 may be spatially varied to reduce and/or eliminate optical aberrations, e.g., to form an adaptive reflecting surface at interface 516. For example, mirror base 204 may house a plurality of electromagnets configured to spatially and/or temporally vary the strength of the magnetic field 550 applied to liquid mirror 502 to compensate for aberrations in other optical components of an optical imaging system, e.g., a secondary mirror or lens of detection module 104, to correct for atmospheric variations and/or turbulence, and/or to correct for, or control, variations in the surface of liquid mirror 502 caused by vibrations, turbulence at a surface of liquid mirror 502, or other external forces. For example, as shown in FIG. 5C, a surface of nonpolar IL 506 may have a relatively rough and/or varying surface, e.g., before applying magnetic field 552. Magnetic field 552, which may have spatially varying magnetic field strengths, may be applies, which may correct, control, and/or smooth one or both of the outer surface of nonpolar IL 506 and interface 516, e.g., resulting in a top surface as shown in FIG. 5B and/or top surface 220 (FIG. 2).

In some examples, mirror base 204 may be non-magnetic, relatively smooth, and configured to wet well to polar IL 510. In some examples, liquid mirror 502 may include walls or side walls to contain nonpolar IL 506 and polar IL 510 (not shown), which may be configured to be non-wetting. For example, such side walls may comprise polytetrafluoroethylene (PTFE).

In some examples, the shape of the reflecting surface of interface 516 may be controlled thermally. For example, in addition to the application of a magnetic field 550, the mirror base 204 may be configured to control the temperature of the surface of mirror base 204 at interface 514 as a function of position and change the properties of polar IL 510 and nonpolar IL 506 as a function of position, e.g., such as viscosity. In some example, the mirror base 204 may be heated to reduce the viscosities of polar IL 510 and nonpolar IL 506, e.g., during the application of the magnetic field 550 to form a shape of the reflecting surface of interface 516, and then cooled to increase the viscosity of polar IL 510 and nonpolar IL 506 to maintain the shape of the reflecting surface of interface 516, e.g., to reduce perturbations and/or changes to the shape of the reflecting surface of interface 516. In some examples, the liquid mirror 502 may be cooled solidify one or both of polar IL 510 and nonpolar IL 506. For example, after forming a focusing surface of interface 516, the mirror base 204 may be cooled to cool polar IL 510 and nonpolar IL 506 to solidify polar IL 510 and nonpolar IL 506, e.g., each of polar IL 510 and nonpolar IL 506 may be cooled to form a non-crystalline solid (e.g., a “glass-like” solid that is substantially amorphous).

An advantage of a liquid mirror 502 so formed is that an acceleration of the liquid mirror 502, (e.g., via gravity or otherwise) or spinning of the liquid mirror 502 is not required in order to form a focusing shape of the reflecting surface of interface 516, and the liquid mirror 502 may be reoriented to point liquid mirror 502 at objects of interest, e.g., liquid mirror 502 may be tipped, tilted, and rotated (relative to the zenith direction, illustrated as the z-direction as shown in FIG. 5D) at one or more particular pitch, roll, and yaw angles of an LMT 402. In some examples, when the magnetic field 550 is applied, the shape of interface 516 may be maintained even against gravity or an acceleration, e.g., when liquid mirror 502 is tipped off zenith as shown in FIG. 5D.

In some examples, reflective particles 508 may comprise silver, gold, or any suitable material having a suitable reflectivity for a desired wavelength range. In some examples, magnetic particles 518 comprising the ferrofluid, e.g., of polar IL 510 of FIGS. 5A and 5B, may be comprised of maghemite, magnetite, or any suitable magnetic material. In some examples, the liquid mirrors 102 and/or 502 may comprise a primary mirror of a telescope. In some examples, the liquid mirrors 102 and/or 502 may comprise a mirror configured for intersatellite communication. As described above, in some examples, the liquid mirrors 102 and/or 502 may be regenerated if disturbed by debris. For example, the liquid mirrors 102 and/or 502 may be configured to “self-heal,” e.g., by allowing the debris may settle to the surface of mirror base 204 at interface 214 and/or 514, and the reflective particles of liquid mirrors 102 and/or 502 may self-assemble to remove any perturbation caused by the debris.

In some examples, a self-assembled LMT, e.g., LMT 402, may include the liquid mirror 502, and may be deployed and regenerated in space and/or on Earth. For example, LMT 402 may be launched and/or deployed with polar IL 510 and nonpolar IL 506 in a reservoir or reservoirs, to be flowed into the surface of mirror base 204 at interface 514 after LMT 402 has reached its target orbit and/or target position. A parabolic reflecting surface of interface 516 may then be formed via the application of a magnetic field 550 to polar IL 510 and nonpolar IL 506 that spreads the reflecting surface of interface 516 to cover mirror base 204 with a coalescence time of about 0.01 seconds, or about 0.1 seconds, or about 0.37 seconds, or about 0.5 seconds, or about 1 second, or about 10 seconds, or any suitable coalescence time, e.g., depending on a gravity and/or acceleration force, the magnetic field 550 and/or magnets, and material and/or surface properties of mirror base 204, polar IL 510 and nonpolar IL 506, reflective particles 508, and magnetic particles 518. In some examples, surface tension and interfacial tension may contribute to holding the polar IL 510 and nonpolar IL 506 against the surface of mirror base 204 at interface 514 and holding interface 516 comprising the reflective particles 508 in place. In some examples, a high surface tension and interfacial tension may contribute to reducing the power required for applying the magnetic field 550 to hold liquid mirror 502, e.g., the reflecting surface of interface 516, in place.

In some examples, a liquid mirror 502 may comprise a single, homogenous ionic liquid. For example, a liquid mirror 502 may comprise a plurality of reflective particles 508 and a plurality of magnetic particles 518, both of which may be suspended in polar IL 510. Polar IL 510 may have a substantially high concentration of suspended reflective particles 508, and a substantially low concentration of the magnetic particles 518, to form a single, homogenous reflecting surface, e.g., with an optically focusing shape such as a paraboloidal shape. For example, liquid mirror 502 may be configured to form interface 516 as a reflecting surface in a single ionic liquid (not shown), e.g., nonpolar IL 506 layer may, instead, be a portion of polar IL 510 that is “above” interface 516, relative to mirror base 204 being “below” interface 516.

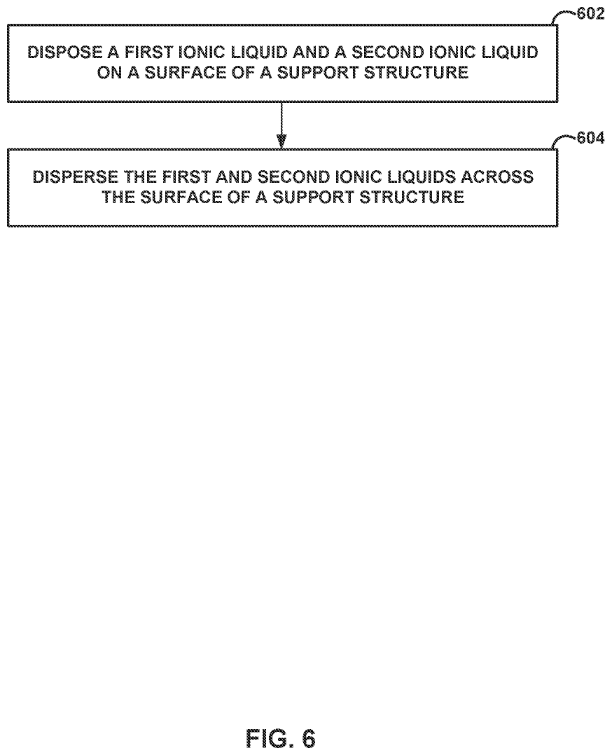

FIG. 6 is a flow diagram illustrating an example technique of forming a liquid mirror. FIG. 6 is described with reference to optical system 100 of FIG. 1, liquid mirror 102 and/or 502 of FIGS. 2 and 5A-5D, and LMT 402 of FIG. 4. However, the techniques of FIG. 6 may be utilized to make different liquid mirrors and/or additional or optical systems.

A system may dispose a first ionic liquid and a second ionic liquid across a surface of a support structure (602). For example, support structure 106 or mirror base 204 may release the first and second ionic liquids from one or more reservoirs within support structure 106 and/or mirror base 204 to flow onto a surface of mirror base 204, e.g., the surface at interface 214 and/or 514. In some examples, the first and second ionic liquids are thoroughly mixed, e.g., before being disposed across the surface, while being disposed across the surface, or after being disposed across the surface. For example, the first and second ionic liquids may be stored in the same reservoir and mixed, e.g., via induced shear. In other examples, the first and second ionic liquids may be stored in the same or different reservoirs and forced through a mixer that applies shear and disperses the first and second ionic liquids, including any particles or nanoparticles contained within either the first and/or the second ionic liquids, within each other.

A system may disperse a first ionic liquid and a second ionic liquid across a surface of a support structure by applying at least one force to the first ionic liquid or the second ionic liquid (604). For example, a vehicle comprising LMT 402 and an ion engine may cause LMT 402 to accelerate and spin. LMT 402 may include optical system 100 and liquid mirror 102, and the acceleration causes a normal force to be applied to first and second ionic liquids 206, 210, and the spin causes a centrifugal force to be applied to first and second ionic liquids 206, 210. The acceleration and spin of LMT 402 may cause first and second ionic liquids 206, 210 to disperse and form an optical focusing shape, such as a paraboloidal shape.

In some examples, optical system 100 may include liquid mirror 502 comprising a polar IL 510, which may be a ferrofluid. Liquid mirror 502 may include one or more permanent magnets and/or electromagnets configured to cause a magnetic field to be applied to polar IL 510. The magnetic field may then interact with ferrofluid polar IL 510 and/or one or more magnetic particles 518 of polar IL 510 to cause a magnetic force to be applied to polar IL 510 to disperse polar IL 510 and non-polar IL 506 to disperse and form interface 516 (comprising a plurality of reflecting particles 508) into a focusing shape, such as a paraboloidal shape.

Select examples of the present disclosure include, but are not limited to, the following examples.

Example 1: A liquid mirror comprising: a first ionic liquid and a second ionic liquid, wherein the first and second ionic liquids are immiscible with each other; and a plurality of reflective particles configured to self-assemble at an interface between the first and second ionic liquids.

Example 2: The liquid mirror of example 1, wherein the interface between the first and second ionic liquids comprises an optically focusing shape.

Example 3: The liquid mirror of example 2, wherein the optically focusing shape is a paraboloidal shape.

Example 4: The liquid mirror of example 2 or example 3, wherein the optically focusing shape is formed by accelerating and spinning the first and second ionic liquids.

Example 5: The liquid mirror of any one of examples 2-4, wherein the optically focusing shape is formed by at least one of gravity or accelerating a structure housing the liquid mirror.

Example 6: The liquid mirror of any one of examples 1-5, wherein the first ionic liquid and the second ionic liquid have at least one matched anion.

Example 7: The liquid mirror of any one of examples 1-6, wherein the first ionic liquid comprises a hydrophobic phosphonium cation and the second ionic liquid comprises a hydrophilic imidazolium cation.

Example 8: The liquid mirror of any one of examples 1-7, wherein the first ionic liquid comprises a nonpolar ionic liquid and the second ionic liquid comprises a polar ionic liquid.

Example 9: The liquid mirror of any one of examples 1-8, wherein the liquid mirror comprises diameter of at least 5 meters and an F/# of about F/2 or less.

Example 10: The liquid mirror of any one of examples 1-9, further comprising: a housing configured to house the first and second ionic liquids, wherein a surface of the housing in contact with the first or second ionic liquid is configured to be heated or cooled.

Example 11: The liquid mirror of example 10, wherein the housing is configured to cool at least one of the first or second ionic liquids such that the first or second ionic liquid forms a non-crystalline solid.

Example 12: The liquid mirror of any one of examples 2-11, wherein the second ionic liquid comprises a ferrofluid, wherein the optically focusing shape is formed by applying a magnetic field to the first ionic liquid.

Example 13: The liquid mirror of example 12, further comprising: a housing configured to house the first and second ionic liquids, wherein the housing comprises at least one magnet configured to apply a magnetic field to the second ionic liquid, and wherein a surface of the housing in contact with the first or second ionic liquid is configured to be heated or cooled.

Example 14: The liquid mirror of example 13, further comprising: a plurality of magnetic particles dispersed within at least one of the first ionic liquid or the second ionic liquid.

Example 15: The liquid mirror of example 14, wherein each magnetic particle of the plurality of magnetic particles is sized such that it comprises one magnetic domain.

Example 16: The liquid mirror of example 14 or example 15, wherein second ionic liquid comprises a polar ionic liquid, wherein the plurality of magnetic particles are configured to wet to the polar ionic liquid.

Example 17: The liquid mirror of example 16, wherein the second ionic liquid comprises a polar ionic liquid, wherein the plurality of reflective particles are configured to not wet well to the polar ionic liquid, wherein the plurality of reflective particles are configured to be less polar than the second ionic liquid.

Example 18: The liquid mirror of example 16 or example 17, wherein a surface of the housing in contact with the second ionic liquid is substantially hydrophilic, wherein the second ionic liquid is substantially hydrophilic.

Example 19: The liquid mirror of example 18, wherein the plurality of magnetic particles are substantially hydrophilic, wherein the first ionic liquid is substantially hydrophobic.

Example 20: The liquid mirror of example 19, wherein the plurality of reflective particles are substantially hydrophobic.

Example 21: The liquid mirror of any one of examples 13-20, wherein a surface of the housing in contact with the first or second ionic liquid and the first and second ionic liquids are configured for a substantially high interfacial tension, wherein the first and second ionic liquids comprise a substantially high viscosity.

Example 22: The liquid mirror of any one of examples 13-21, wherein the housing is configured to be at least one of rotated, tipped, or tilted, wherein the liquid mirror is configured to maintain the optically focusing shape when the housing is at least one of rotated, tipped, or tilted.

Example 23: The liquid mirror of any one of examples 1-20, wherein the first and second ionic liquids are configured to reduce a standing wave perturbation of a surface shape of the interface between the first and second ionic liquids.

Example 24: The liquid mirror of any one of examples 1-23, wherein the liquid mirror is configured to self-heal upon contact with debris.

Example 25: The liquid mirror of any one of examples 1-24, wherein the liquid mirror comprises a diameter of about 10 meters, an effective focal length of about 20 meters, a depth of curvature of about 0.3 meters, a maximum layer thickness of the first ionic liquid of less than or equal to about 2 millimeters, and a maximum layer thickness of the second ionic liquid of less than or equal to 2 millimeters.

Example 26: The liquid mirror of any one of examples 1-25, wherein the first and second ionic liquids comprise a non-volatile liquid.

Example 27: A vehicle comprising: a housing configured to couple an engine to a liquid mirror; the engine configured to provide thrust to the housing and liquid mirror in a thrust direction; and the liquid mirror, wherein the liquid mirror comprises: a first ionic liquid and a second ionic liquid, wherein the first and second ionic liquids are immiscible with each other; and a plurality of reflective particles configured to self-assemble at an interface between the first and second ionic liquids.

Example 28: The vehicle of example 27, wherein the engine comprises and ion engine.

Example 29: The vehicle of example 27, wherein the interface between the first and second ionic liquids comprises an optically focusing shape.

Example 30: The vehicle of example 29, wherein the optically focusing shape is a paraboloidal shape.

Example 31: The vehicle of example 29 or example 30, wherein the optically focusing shape is formed by accelerating and spinning the first and second ionic liquids.

Example 32: The vehicle of any one of examples 29-31, wherein the optically focusing shape is formed by at least one of gravity or accelerating a structure housing the liquid mirror.

Example 33: The vehicle of any one of examples 27-32, wherein the first ionic liquid and the second ionic liquid have at least one matched anion.

Example 34: The vehicle of any one of examples 27-33, wherein the first ionic liquid comprises a hydrophobic phosphonium cation and the second ionic liquid comprises a hydrophilic imidazolium cation.

Example 35: The vehicle of any one of examples 27-34, wherein the first ionic liquid comprises a nonpolar ionic liquid and the second ionic liquid comprises a polar ionic liquid.

Example 36: The vehicle of any one of examples 27-35, wherein the liquid mirror comprises diameter of at least 5 meters and an F/# of about F/2 or less.

Example 37: The vehicle of any one of examples 27-36, wherein the liquid mirror further comprises: a mirror housing configured to house the first and second ionic liquids, wherein a surface of the mirror housing in contact with the first or second ionic liquid is configured to be heated or cooled.

Example 38: The vehicle of example 37, wherein the mirror housing is configured to cool at least one of the first or second ionic liquids such that the first or second ionic liquid forms a non-crystalline solid.

Example 39: The vehicle of any one of examples 28-38, wherein the second ionic liquid comprises a ferrofluid, wherein the optically focusing shape is formed by applying a magnetic field to the second ionic liquid.

Example 40: The vehicle of example 39, wherein the liquid mirror further comprises: a mirror housing configured to house the first and second ionic liquids, wherein the mirror housing comprises at least one magnet configured to apply a magnetic field to the second ionic liquid, and wherein a surface of the mirror housing in contact with the first or second ionic liquid is configured to be heated or cooled.

Example 41: The vehicle of example 40, further comprising: a plurality of magnetic particles dispersed within at least one of the first ionic liquid or the second ionic liquid.

Example 42: The vehicle of example 41, wherein each magnetic particle of the plurality of magnetic particles is sized such that it comprises one magnetic domain.

Example 43: The vehicle of example 41 or example 42, wherein second ionic liquid comprises a polar ionic liquid, wherein the plurality of magnetic particles are configured to wet to the polar ionic liquid.

Example 44: The vehicle of example 43, wherein the second ionic liquid comprises a polar ionic liquid, wherein the plurality of reflective particles are configured to not wet well to the polar ionic liquid, where in the plurality of reflective particles are configured to be less polar than the second ionic liquid.

Example 45: The vehicle of example 43 or example 44, wherein a surface of the mirror housing in contact with the second ionic liquid is substantially hydrophilic, wherein the second ionic liquid is substantially hydrophilic.

Example 46: The vehicle of example 45, wherein the plurality of magnetic particles are substantially hydrophilic, wherein the second ionic liquid is substantially hydrophobic.

Example 47: The vehicle of example 46, wherein the plurality of reflective particles are substantially hydrophobic.

Example 48: The vehicle of any one of examples 40-47, wherein a surface of the mirror housing in contact with the first or second ionic liquid and the first and second ionic liquids are configured for a substantially high interfacial tension, wherein the first and second ionic liquids comprise a substantially high viscosity.

Example 49: The vehicle of any one of examples 40-48, wherein the mirror housing is configured to be at least one of rotated, tipped, or tilted, wherein the liquid mirror is configured to maintain the optically focusing shape when the mirror housing is at least one of rotated, tipped, or tilted.

Example 50: The vehicle of any one of examples 27-49, wherein the first and second ionic liquids are configured to reduce a standing wave perturbation of a surface shape of the interface between the first and second ionic liquids.

Example 51: The vehicle of any one of examples 27-50, wherein the liquid mirror is configured to self-heal upon contact with debris.

Example 52: The vehicle of any one of examples 27-51, wherein the liquid mirror comprises a diameter of about 10 meters, an effective focal length of about 20 meters, a depth of curvature of about 0.3 meters, a maximum layer thickness of the first ionic liquid of less than or equal to about 2 millimeters, and a maximum layer thickness of the second ionic liquid of less than or equal to 2 millimeters.

Example 53: The vehicle of any one of examples 27-52, wherein the first and second ionic liquids comprise a non-volatile liquid.

Example 54: A method of forming a liquid mirror comprising: dispersing a first ionic liquid and a second ionic liquid across a surface of a support structure by applying at least one force to the first ionic liquid or the second ionic liquid, wherein the first and second ionic liquids are immiscible with each other, wherein at least one of the first or second ionic liquids comprises a plurality of reflective particles configured to self-assemble at an interface between the first and second ionic liquids.

Example 55: The method of example 54, wherein the at least one force comprises a force due to an acceleration and a centrifugal force, wherein the interface between the first and second ionic liquids comprises an optically focusing shape.

Example 56: The method of example 54, wherein the second ionic liquid comprises a ferrofluid, wherein applying the at least one force comprises applying a magnetic field to the second ionic liquid, wherein the interface between the first and second ionic liquids comprises an optically focusing shape.

Various examples have been described. These and other examples are within the scope of the following claims.

What is claimed is:

1. A liquid mirror comprising:
a first ionic liquid and a second ionic liquid, wherein the first and second ionic liquids are immiscible with each other; and
a plurality of reflective particles configured to self-assemble at an interface between the first and second ionic liquids.

2. The liquid mirror of claim 1, wherein the interface between the first and second ionic liquids comprises an optically focusing shape.

3. The liquid mirror of claim 2, wherein the optically focusing shape is a paraboloidal shape.

4. The liquid mirror of claim 2, wherein the optically focusing shape is formed by accelerating and spinning the first and second ionic liquids.

5. The liquid mirror of claim 2, wherein the optically focusing shape is formed by at least one of gravity or accelerating a structure housing the liquid mirror.

6. The liquid mirror of claim 1, wherein the first ionic liquid and the second ionic liquid have at least one matched anion.

7. The liquid mirror of claim 1, wherein the first ionic liquid comprises at least one of a hydrophobic cation or a hydrophobic phosphonium cation and the second ionic liquid comprises at last one of a hydrophilic cation or a hydrophilic imidazolium cation.

8. The liquid mirror of claim 1, wherein the first ionic liquid comprises a nonpolar ionic liquid and the second ionic liquid comprises a polar ionic liquid.

9. The liquid mirror of claim 1, wherein the liquid mirror comprises diameter of at least 5 meters and an F/# of about F/2 or less.

10. The liquid mirror of claim 1, further comprising:
a housing configured to house the first and second ionic liquids, wherein a surface of the housing in contact with the first or second ionic liquid is configured to be heated or cooled, wherein the housing is configured to cool at least one of the first or second ionic liquids such that the first or second ionic liquid forms a non-crystalline solid.

11. The liquid mirror of claim 2, wherein the second ionic liquid comprises a ferrofluid, wherein the optically focusing shape is formed by applying a magnetic field to the second ionic liquid.

12. The liquid mirror of claim 11, further comprising:
a plurality of magnetic particles dispersed within at least one of the first ionic liquid or the second ionic liquid; and
a housing configured to house the first and second ionic liquids,
wherein the housing comprises at least one magnet configured to apply a magnetic field to the second ionic liquid, and
wherein a surface of the housing in contact with the first or second ionic liquid is configured to be heated or cooled.

13. The liquid mirror of claim 12, wherein each magnetic particle of the plurality of magnetic particles is sized such that it comprises one magnetic domain,
wherein first ionic liquid comprises a nonpolar ionic liquid,
wherein the second ionic liquid comprises a polar ionic liquid, wherein the plurality of magnetic particles are configured to wet to the polar ionic liquid, wherein the plurality of reflective particles are configured to not wet well to the polar ionic liquid, where in the plurality of reflective particles are configured to be less polar than the second ionic liquid,
wherein a surface of the housing in contact with the second ionic liquid is substantially hydrophilic, wherein the second ionic liquid is substantially hydrophilic,
wherein the plurality of magnetic particles are substantially hydrophilic, wherein the first ionic liquid is substantially hydrophobic,
wherein the plurality of reflective particles are substantially hydrophobic.

14. The liquid mirror of claim 13, wherein a surface of the housing in contact with the first or second ionic liquid and the first and second ionic liquids are configured for a substantially high interfacial tension, wherein the first and second ionic liquids comprise a substantially high viscosity,
wherein the housing is configured to be at least one of rotated, tipped, or tilted, wherein the liquid mirror is configured to maintain the optically focusing shape when the housing is at least one of rotated, tipped, or tilted.

15. The liquid mirror of claim 1, wherein the first and second ionic liquids are configured to reduce a standing wave perturbation of a surface shape of the interface between the first and second ionic liquids.

16. The liquid mirror of claim 1, wherein the liquid mirror is configured to self-heal upon contact with debris, wherein the first and second ionic liquids comprise a non-volatile liquid.

17. The liquid mirror of claim 1, wherein the liquid mirror comprises a diameter of about 10 meters, an effective focal length of about 20 meters, a depth of curvature of about 0.3 meters, a maximum layer thickness of the first ionic liquid of less than or equal to about 2 millimeters, and a maximum layer thickness of the second ionic liquid of less than or equal to 2 millimeters.

18. A vehicle comprising:
a housing configured to couple an engine to a liquid mirror;
the engine configured to provide thrust to the housing and liquid mirror in a thrust direction; and
the liquid mirror, wherein the liquid mirror comprises:
a first ionic liquid and a second ionic liquid, wherein the first and second ionic liquids are immiscible with each other; and
a plurality of reflective particles configured to self-assemble at an interface between the first and second ionic liquids.

19. The vehicle of claim 18, wherein the engine comprises and ion engine.

20. A method of forming a liquid mirror comprising:
dispersing a first ionic liquid and a second ionic liquid across a surface of a support structure by applying at least one force to the first ionic liquid or the second ionic liquid,
wherein the first and second ionic liquids are immiscible with each other,
wherein at least one of the first or second ionic liquids comprises a plurality of reflective particles configured to self-assemble at an interface between the first and second ionic liquids.
